(19) United States
(12) Patent Application Publication
(10) Pub. No.: US 2006/0003240 A1
(43) Pub. Date: Jan. 5, 2006

(54) Methods for adjusting light intensity for photolithography and related systems

(76) Inventors: Woo-Seok Shim, Gyeonggi-do (KR); Dae-Youp Lee, Gyeonggi-do (KR); Joon-Sung Kim, Gyeonggi-do (KR); In-Sang Song, Seoul (KR); Yong-Jin Cho, Gyeonggi-do (KR)

Correspondence Address: MYERS BIGEL SIBLEY & SAJOVEC, PO BOX 37428, RALEIGH, NC, 27627, US

(21) Appl. No.: 11/153,787

(22) Filed: Jun. 15, 2005

(30) Foreign Application Priority Data
Jun. 30, 2004 (KR) 2004-50194

(51) Int. Cl. G03C 5/00; G03B 27/00

(52) U.S. Cl. 430/30; 355/18

(57) ABSTRACT

Correcting light intensity for photolithography may include irradiating light having a first light intensity distribution through a photo mask having a mask pattern to a photosensitive layer on a wafer to form a first pattern corresponding to the mask pattern. A distribution of critical dimensions of the first pattern corresponding to the mask pattern may be determined, and a second light intensity distribution may be determined based on a relation between the first light intensity distribution and the distribution of critical dimensions of the first pattern. Then, light having the second light intensity distribution may be irradiated. Related systems are also discussed.

### RELATED APPLICATION

This application claims the benefit of priority under 35 USC § 119 to Korean Patent Application No. 2004-50194, filed on Jun. 30, 2004, the disclosure of which is hereby incorporated herein by reference in its entirety.

### FIELD OF THE INVENTION

The present invention relates to microelectronics fabrication, and more particularly to methods and systems for photolithography.

### BACKGROUND

Generally, a semiconductor integrated circuit may be formed by implanting impurities into regions of a silicon substrate, and by electrically interconnecting the regions to form circuits. Patterns defining the regions may be formed using photolithography processes.

In a photolithography process, a surface of a wafer is cleaned. To enhance adhesion between a layer to be patterned and a photoresist film, a surface-treating process may be performed on the wafer. A liquid photoresist is then spin coated on the wafer and baked to form a photoresist film. Radiation such as ultraviolet radiation, an electron beam, and/or an X-ray is selectively irradiated on the photoresist film to selectively expose portions of the photoresist film. A developer may be provided on the exposed photoresist film to form a photoresist pattern on the wafer. Portions of regions/layers beneath the photoresist pattern may be protected by the photoresist pattern. A subsequent process such as a lift-off process, an etching process, etc., may be performed on other portions of the regions/layers exposed through the photoresist film to transfer a shape of the photoresist pattern into the layer.

A tool such as a reticle and/or a mask may be used in a photolithography process. A reticle may include an image that is stepped and repeated to expose an entire wafer. A mask may include a pattern that is transferred to an entire wafer using a single exposure. A reticle may be used to print the stepped and repeated pattern image on the mask. Also, a reticle may be used to directly print the stepped and repeated pattern image on a wafer using a stepper.

In a conventional method of forming a photo mask used in photolithography process, a blank mask may include a light-shielding layer on a transparent mask substrate (such as a quartz or glass substrate), and an electron beam resist on the light-shielding layer. An electron beam may be selectively irradiated on the electron beam resist using a stepper to selectively expose the electron beam resist. A developer may be provided on the exposed electron beam resist to form an electron beam resist pattern. The light-shielding layer is partially etched using the electron beam resist pattern as an etching mask to form a light-shielding layer pattern. The electron beam resist pattern is then removed to complete the photo mask.

The conventional photo mask may include the light-shielding layer pattern having a critical dimension different than a designed critical dimension due to process irregularities for forming patterns so that intervals between the patterns may be non-uniform. When the photolithography process is performed using a conventional photo mask having non-uniformities such as those shown in FIGS. 1 and 2, failures may be generated in corresponding patterns on the wafer.

FIGS. 1A and 1B are plan views illustrating pattern failures on wafers resulting from a conventional photo mask having non-uniformities. FIG. 2 is a map illustrating a critical dimension distribution of the patterns in FIGS. 1A and 1B. Referring to FIGS. 1A, 1B and 2, when patterns are formed using the conventional photo mask, the patterns may lift in a region having a relatively wide critical dimension of about 0.1 μm (micrometer) to about 0.11 μm (micrometer) (see FIG. 2), and adjacent patterns may bridge to each other in a region having a relatively narrow critical dimension of about 0.06 μm (micrometer) to about 0.07 μm (micrometer) (see FIG. 2).

To reduce non-uniformities of patterns due to a photo mask, a photo mask, a method of forming the photo mask and an exposing method using the photo mask are disclosed in Korean Patent Laid Open Publication No. 2004-0031907, the disclosure of which is hereby incorporated herein in its entirety by reference. The conventional photo mask includes a main pattern to be transcribed into a wafer, and a transmittance-controlling pattern to control intensity of a light that is irradiated onto the main pattern. The transmittance-control pattern has densities that vary across different regions that are defined on the wafer.

Here, a uniformity of a pattern may be classified as in-wafer uniformity (IWU) and in-field uniformity (IFU). Because the IFU varies in accordance with a critical dimension of a photo mask, the IFU may be difficult to control in a photolithography process. More particularly, a uniformity of a critical dimension of a manufactured photo mask may be uncorrected. Thus, when defects are generated in the photo mask, the defective photo mask may not be reproduced. As a result, when a photolithography process is carried out using a defective photo mask, non-uniformities of the failed photo mask may have a great influence on the IFU, causing failure of a pattern and reducing a yield for manufacturing a semiconductor device.

### SUMMARY

Some embodiments of the present invention may provide methods of correcting a light intensity that is capable of forming a pattern having relatively uniform critical dimensions on a wafer. Some embodiments of the present invention may also provide systems configured to perform correcting methods. Some embodiements of the present invention may also provide methods of exposing a wafer that are capable of forming patterns having relatively uniform critical dimensions on a wafer. Some embodiments of the present invention may also provide systems configured to perform exposing methods.

In methods of correcting a light intensity according to some embodiments of the present invention, a first light having a first light intensity distribution is irradiated onto a wafer through a mask pattern of a photo mask to form a first actual pattern on the wafer. A distribution of critical dimensions of the actual pattern is then measured. A second light intensity distribution used to form a second actual pattern having relatively uniform critical dimensions is obtained based on a relation between the first light intensity distribution and the critical dimension distribution. The first light is then corrected to convert the first light into a second light having the second light intensity distribution. According to some embodiments, data of the second light intensity distribution is stored.

According to other embodiments, obtaining the second light intensity distribution may include setting a reference critical dimension from the critical dimensions. The critical dimensions are compared with the reference critical dimension to obtain a deviation of the critical dimensions. The second light intensity distribution may then be obtained based on deviations of the critical dimensions.

A system configured to correct a light intensity according to embodiments of the present invention may include an optical unit to partially change a path of a light to correct a light intensity distribution of the light that is irradiated to a mask pattern of a photo mask. A detecting unit detects a distribution of critical dimensions of a first actual pattern on a wafer that is formed by a first light having a first light intensity distribution. A calculating unit calculates a second light intensity distribution used to form a second pattern having uniform critical dimensions based on a relation between the first light intensity distribution and the critical dimension distribution. A controlling unit controls the optical unit to convert the first light into a second light having the second light intensity distribution. According to some embodiments, data of the second light intensity distribution is stored in a storing unit.

According to other embodiments, the calculating unit includes a setter, a first calculator and a second calculator. The setter sets a reference critical dimension from the critical dimensions. The first calculator compares the reference critical dimension with the critical dimensions to calculate a deviation of the critical dimensions. The second calculator calculates the second light intensity distribution based on the deviation of the critical dimensions.

In methods of exposing a wafer according to still other embodiments of the present invention, a first light having a first light intensity distribution is irradiated onto a wafer through a mask pattern of a photo mask to form a first actual pattern on the wafer. A distribution of critical dimensions of the first actual pattern is then measured. A second light intensity distribution used for forming a second actual pattern having uniform critical dimensions is obtained based on a relation between the first light intensity distribution and the critical dimension distribution. The first light is then corrected to convert the first light into a second light having the second light intensity distribution. The second light is irradiated onto the wafer through the mask pattern to form the second actual pattern on the wafer.

A system configured to expose a wafer according to still other embodiments of the present invention includes a light source configured to emit a light that is irradiated onto the wafer through a mask pattern of a photo mask. An optical unit partially changes a path of the light to correct a light intensity distribution of the light. A detecting unit detects a distribution of critical dimensions of a first actual pattern on a wafer that is formed by a first light having a first light intensity distribution. A calculating unit calculates a second light intensity distribution used to form a second actual pattern having uniform critical dimensions based on a relation between the first light intensity distribution and the critical dimension distribution. A controlling unit controls the optical unit to convert the first light into a second light having the second light intensity distribution.

According to embodiments of the present invention, a deviation of critical dimensions of an actual pattern on the wafer is obtained. The first light is corrected to reduce the deviation so that the second light has the second light intensity distribution. Thus, the second actual pattern having uniform critical dimensions may be formed on the wafer using the photo mask.

### BRIEF DESCRIPTION OF THE DRAWINGS

FIGS. 1A and 1B are plan views illustrating defective patterns on a wafer due to a conventional photo mask having non-uniform critical dimensions.

FIG. 2 is a map illustrating a critical dimension distribution of the patterns in FIGS. 1A and 1B.

FIG. 3 is a block diagram illustrating systems configured to correct a light intensity according to some embodiments of the present invention.

FIG. 4 is a block diagram illustrating embodiments of a calculating unit of FIG. 3 according to some embodiments of the present invention.

FIG. 5 is a flow chart illustrating operations of correcting a light intensity using systems of FIG. 3.

FIG. 6 is a flow chart illustrating operations of obtaining a light intensity distribution in FIG. 5.

FIG. 7 is a block diagram illustrating systems configured to expose a wafer according to other embodiments of the present invention.

FIG. 8 is a flow chart illustrating operations of exposing a wafer using systems of FIG. 7.

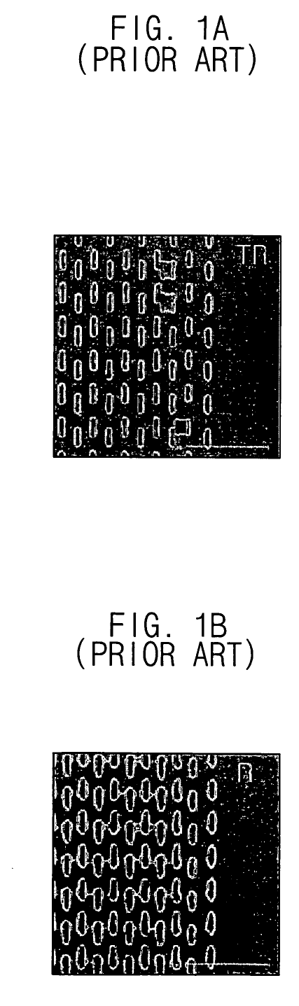

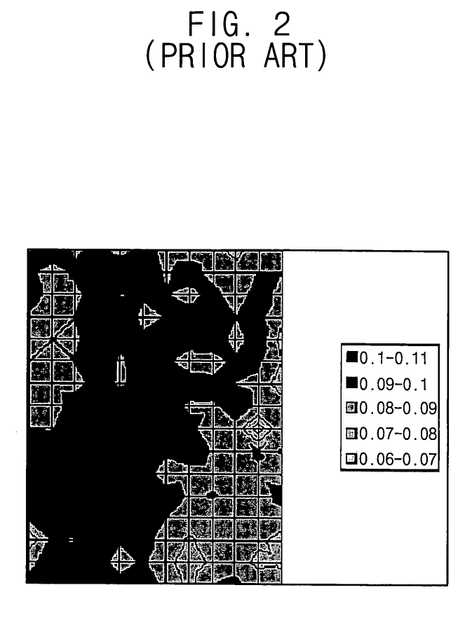

### DETAILED DESCRIPTION

The present invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “comprises”, “comprising”, “includes”, and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

FIG. 3 is a block diagram illustrating systems configured to correct a light intensity according to some embodiments of the present invention. Referring to FIG. 3, a system 100 configured to correct a light intensity may include an optical unit 110, a detecting unit 120, a calculating unit 130, a data-storing unit 140 and a controlling unit 150.

The optical unit 110 changes a path of a light emitted from a light source (not shown) to control a light intensity distribution of the light. The light controlled by the optical unit 110 is irradiated onto a photo mask (not shown) having a mask pattern. The optical unit 110 includes a micro mirror array 112 configured to reflect the light, and a driver 114 configured to adjust angles of mirrors in the micro mirror array 112.

Each mirror may have a size of about 50 μm×about 50 μm and the mirrors may be arranged in a matrix pattern. The micro mirror array 112 may reflect the light in different directions. Thus the light may be reflected in a specific direction without significant loss of energy in the light. To enhance a refractivity of the micro mirror array 112, the micro mirrors of the array 112 may include reflecting materials having different refractivities that are alternatively stacked.

The driver 114 may be positioned on rear faces of the mirrors in the micro mirror array 112. The driver 114 separately controls angles of each of the mirrors in accordance with a signal input to the driver 114. Because the angles of the mirrors are desirably adjusted separately, light reflected from different mirrors of the micro mirror array 112 may have different light intensity distributions in accordance with positions (corresponding to different mirrors) where the light is irradiated. The driver 114 may be operated using static electricity and/or an electric signal provided from the exterior.

Each of the mirrors may thus reflect light in directions different from each other in accordance with different angles of the mirrors. Therefore, a light intensity distribution may be controlled to reflect an amount of the light toward a region where a relatively high light intensity is desired, greater than that of the light toward another region where a relatively low light intensity is desired. As a result, the reflected light may be provided with varying light intensity distributions.

The detecting unit 120 is configured to detect a distribution of critical dimensions of the mask pattern to be transcribed into the wafer. The detecting unit 120 is positioned over the wafer. The detecting unit 120 may include a sensor configured to sense intensities of the light having a first light intensity distribution that is irradiated onto the wafer through the photo mask. While the light is irradiated onto the wafer, the sensor may detect intensities of the light by moving in an X direction and a Y direction substantially perpendicular to the X direction. An optical sensor is an example of a sensor that may be used. A critical dimension distribution detected by the detecting unit 120 may be displayed on a map similar to that illustrated in FIG. 2. The critical dimension distribution may be non-uniform.

The calculating unit 130 is configured to calculate a second light intensity distribution of a reference light using the critical dimension distribution provided by the detecting unit. The reference light may be used to form a virtual pattern having uniform critical dimensions. Here, the critical dimension distribution is related to the first light intensity distribution. That is, when the first light intensity distribution changes, the critical dimension of the actual pattern on the wafer also changes. The calculating unit 130 may calculate the second light intensity distribution based on a relation between the critical dimension distribution and the first light intensity distribution.

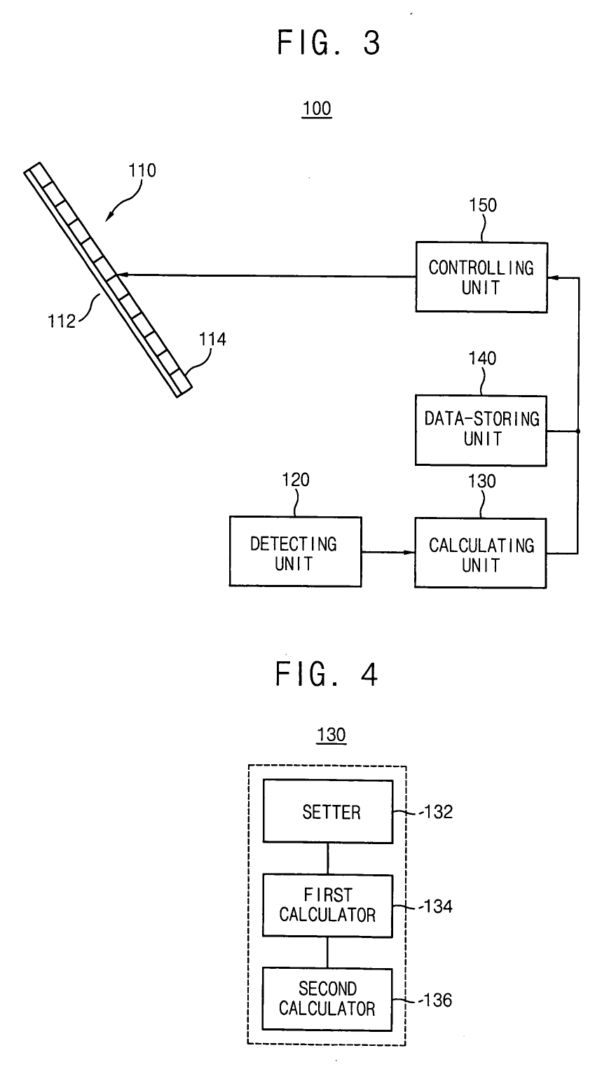

FIG. 4 is a block diagram illustrating embodiments of the calculating unit in FIG. 3. Referring to FIG. 4, the calculating unit 130 may include a setter 132, a first calculator 134 and a second calculator 136. The setter 132 may set a reference critical dimension among the reference critical dimensions detected by the detecting unit 120. The reference critical dimension may correspond to a minimum critical dimension.

The first calculator 134 may compare the reference critical dimension with the detected critical dimensions to calculate a deviation of the critical dimensions. The deviation of the critical dimensions may be calculated using an equation used to calculate a deviation of values.

The second calculator 136 may correct the first light intensity distribution of the light (which is irradiated onto the photo mask) based on deviation of the critical dimensions as calculated by the first calculator 134 to reduce deviation of the critical dimensions. The light irradiated onto the photo mask may thus have a light intensity distribution substantially identical to the second light intensity distribution so that a pattern on the wafer may have relatively uniform critical dimensions.

Data of the second light intensity distribution may be stored in the data-storing unit 140. When data of the second light intensity distributions with respect to various lights are obtained, a database may be provided in the data-storing unit 140.

The controlling unit 150 may control the optical unit 110 in accordance with the second light intensity distribution calculated by the calculating unit 130. That is, the controlling unit 150 may control the driver 114 to irradiate a second light having the second light intensity distribution onto the photo mask.

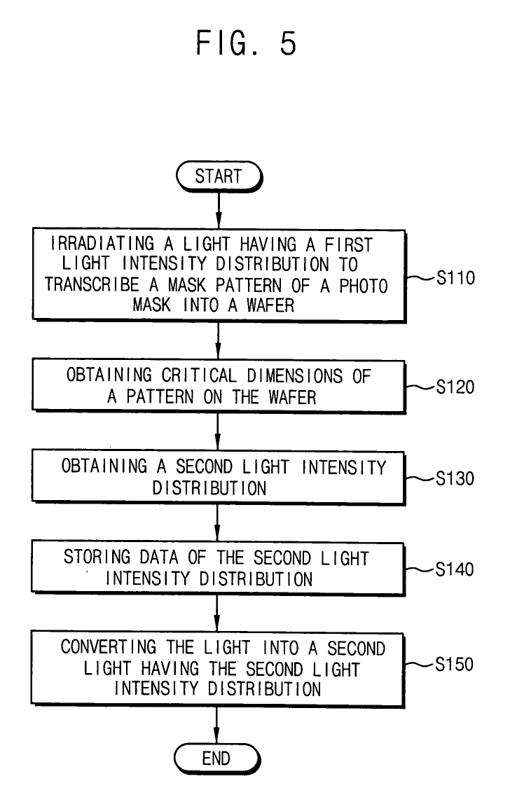

FIG. 5 is a flow chart illustrating methods of correcting a light intensity using systems to FIG. 3. Referring to FIG. 5, in step S110, the light having the first light intensity distribution may be irradiated onto the wafer through the photo mask having the mask pattern to transcribe the mask pattern into the wafer, thereby forming the actual pattern on the wafer. Here, the actual pattern may have non-uniform critical dimensions.

In step S120, the detecting unit 120 detects the intensity of the light using the sensor of detecting unit 120. The distribution of the critical dimensions of the actual pattern may be displayed as a map based on the detected intensities. Alternatively, the detecting unit 120 may detect the critical dimension distribution based on the actual pattern on the wafer.

In step S130, the calculating unit 130 may calculate the second light intensity distribution based on a relation between the critical dimension distribution and the first light intensity distribution. The second light intensity distribution corresponds to a light intensity distribution used to form a pattern having substantially uniform critical dimensions.

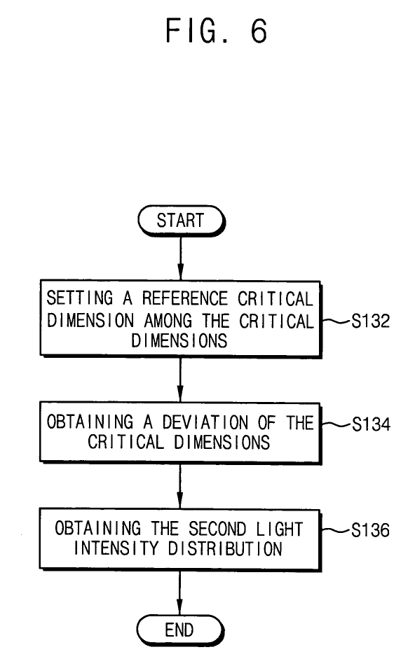

FIG. 6 is a flow chart illustrating methods of obtaining the second light intensity distribution in FIG. 5. Referring to FIG. 6, in step S132, a minimum critical dimension may be selected among the critical dimensions shown in the map. The setter 132 may set the minimum critical dimension as a reference critical dimension.

In step S134, the first calculator 134 may compare the reference critical dimension with the detected critical dimensions to calculate deviations of the critical dimensions. Deviations of the critical dimensions may be related to the first light intensity distribution.

In step S136, the second calculator 136 may calculate the second light intensity distribution based on relations between the critical dimensions and the first light intensity distribution to reduce a deviation of the critical dimensions.

Referring now to FIG. 5, in step S140, the second light intensity distributions obtained from various lights may be stored in the data-storing unit 140 to provide a database in the storing unit 140. In step S150, the controlling unit 150 may control the driver 114 of the optical unit 110 responsive to the second light intensity distribution calculated by the calculating unit 130. Alternatively, the controlling unit 150 may control the driver 114 based on the second light intensity distributions stored in the data-storing unit 140. The driver 114 may separately adjust angles of separate mirrors of the micro mirror array 112. Thus, light may be converted into the second light having the second light intensity distribution.

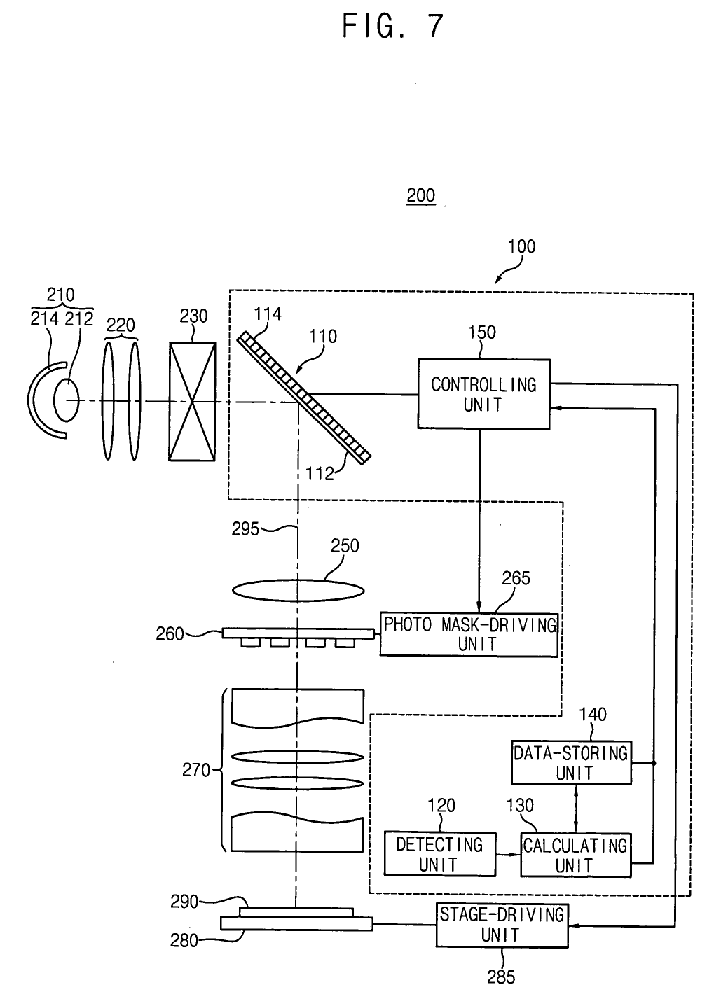

FIG. 7 is a block diagram illustrating systems configured to expose a wafer in accordance with additional embodiments of the present invention. Referring to FIG. 7, a system 200 configured to expose a wafer may include a light source 210, a condensing lens unit 220, a fly's eye lens array 230, the optical unit 110, an illuminating lens 250, a photo mask 260, a projection lens unit 270, the detecting unit 120, the calculating unit 130 and the controlling unit 150.

The light source 210 may include a mercury lamp 212 and a semi-spherical mirror 214. The mercury lamp 212 may emit a light having a relatively short wavelength to accommodate relatively high integration of a semiconductor device being fabricated. Examples of such light sources may include a g-line beam having a wavelength of about 436 nm, a beam having a wavelength of about 365 nm, etc.

Alternatively, the light source 210 may include a laser beam-emitting device configured to emit a laser beam having a relatively short wavelength in place of the mercury lamp 212 and the semi-spherical mirror 214. In particular, the light source 210 may include a KrF excimer laser configured to emit a laser beam having a wavelength of about 248 nm, an ArF excimer laser configured to emit a laser beam having a wavelength of about 198 nm, an F₂ excimer laser configured to emit a laser beam having a wavelength of about 157 nm, etc.

Light emitted from the mercury lamp 212 in different directions may be reflected from the semi-spherical mirror 214 in substantially one direction. Here, an optical axis 295 may be connected between the light source 210 and the wafer 290 through centers of the illuminating lens 250 and the projection lens 270. The condensing lens unit 220 may condense light emitted from the light source 210. The fly's eye lens array 230 may diffuse the condensed light to irradiate the condensed light onto the wafer 290 with substantial uniformity.

The optical unit 110 may be arranged between the fly's eye lens array 230 and the illuminating lens 250. More particularly, the optical unit may be slanted to the fly's eye lens array 230 and the illuminating lens 250. Light passing through the fly's eye lens array 230 may be reflected from the optical unit 110 toward the illuminating lens 250. As described above, the optical unit 110 may change a path of the light to control a light intensity distribution of the light. The light having the controlled light intensity distribution is irradiated onto a photo mask 260 having a mask pattern thereon.

The optical unit 110 includes a micro mirror array 112 configured to reflect the light, and a driver 114 configured to adjust angles of mirrors in the micro mirror array 112. The micro mirror array 112 and the driver 114 are discussed in greater detail with reference to FIG. 3. Further illustration and/or discussion of the micro mirror array 112 and the driver 114 is thus omitted. The illuminating lens 250 may condense light reflected from the optical unit 110. The photo mask 260 may include a mask pattern thereon. The condensed light may be irradiated to the photo mask 260 and through the mask pattern thereon, and a photo mask-driving unit 265 may move the photo mask 260 in an X direction. Additionally, a slit may be provided to adjust a width of the light, and the slit may be arrayed between the illuminating lens 250 and the photo mask 260.

The light passing through the photo mask 260 may be focused on the wafer 290 on a stage 280 through the projecting lens unit 270. A stage-driving unit 285 may move the stage 280 in X and Y directions. In an exposing process, the stage 280 and the photo mask 260 may be moved in the X directions opposite to each other. As a result, the mask pattern of the photo mask 260 may be transcribed into a photoresist film on the wafer 290.

The detecting unit 120, the calculating unit 130, the data-storing unit 140 and the controlling unit 150 are illustrated and discussed in greater detail with reference to FIG. 3. Further illustration and/or discussion of the detecting unit 120, the calculating unit 130, the data-storing unit 140 and the controlling unit 150 is thus omitted.

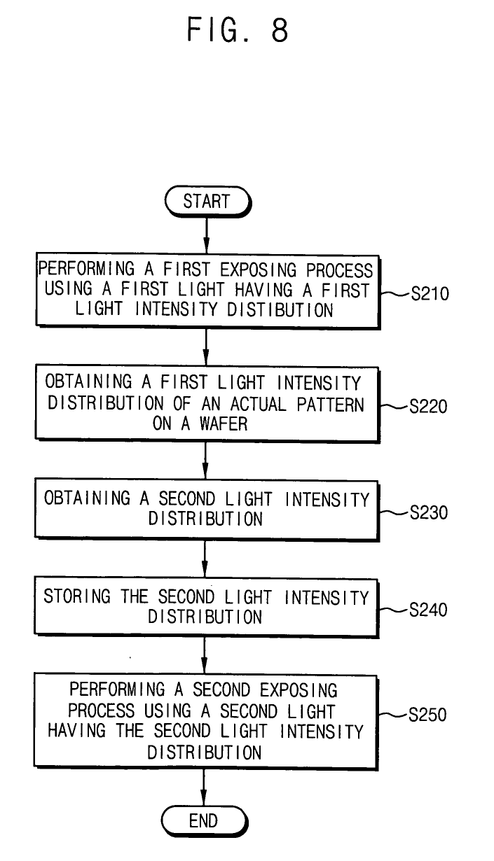

FIG. 8 is a flow chart illustrating methods of exposing a wafer using systems of FIG. 7. Referring to FIG. 8, in step S210, a first exposing process may be carried out. In particular, first light emitted from the mercury lamp 212 may be reflected from the semi-spherical mirror 214. The reflected first light is irradiated to the condensing lens 220 and is then condensed. The condensed first light is irradiated to the fly's eye lens array 230. The first light passing through the fly's eye lens array 230 is irradiated to the micro mirror array 112 of the optical unit 110 so that the first light has the first light intensity distribution. The first light having the first light intensity distribution is irradiated to the illuminating lens 250. The first light passing through the illuminating lens 250 is irradiated onto the wafer 290 on the stage 280 to transcribe the mask pattern of the photo mask 260 into the wafer 290, thereby forming the first actual pattern on the wafer. Here, the first actual pattern may have non-uniform critical dimensions.

In step S220, the detecting unit 120 detects the light intensity of the first light using a sensor thereof. A distribution of the critical dimensions of the first actual pattern may be displayed in a map based on the detected intensity. Alternatively, the detecting unit 120 may detect the critical dimension distribution based on the first actual pattern on the wafer 290.

In step S230, the calculating unit 130 calculates the second light intensity distribution based on the relation between the critical dimension distribution and the first light intensity distribution. The second light intensity distribution corresponds to a light intensity distribution used to form a pattern having substantially uniform critical dimensions. A process for obtaining the second light intensity distribution may be substantially identical to that illustrated with reference to FIG. 6. Further illustration and/or discussion of the process is thus omitted.

In step S240, second light intensity distributions obtained from various lights may be stored in the data-storing unit 140 to provide a database in the storing unit 140. The controlling unit 150 may control the driver 114 of the optical unit 110 based on second light intensity distributions calculated by the calculating unit 130. Alternatively, the controlling unit 150 may control the driver 114 based on second light intensity distributions stored in the data-storing unit 140.

In step S250, a second exposing process may be performed. In particular, the driver may separately adjust angles of mirrors of the micro mirror array 112. The second light emitted from the mercury lamp 212 may be reflected from the semi-spherical mirror 214. The reflected second light may be irradiated to the condensing lens 220 and then condensed. The condensed second light may be irradiated to the fly's eye lens array 230. The second light passing through the fly's eye lens array 230 may be irradiated to the micro mirror array 112 of the optical unit 110 so that the second light has the second light intensity distribution. The second light having the second light intensity distribution may be irradiated to the illuminating lens 250. The second light passing through the illuminating lens 250 may be irradiated onto the wafer 290 on the stage 280 to transcribe the mask pattern of the photo mask 260 into the wafer 290, thereby forming the second actual pattern on the wafer 290. Because the second actual pattern has the corrected second light intensity distribution, the second actual pattern may have substantially uniform critical dimensions.

After the angles of the micro mirror array 112 are adjusted in accordance with the second light intensity distribution, the second light passing through the fly's eye lens array 230 is irradiated to the micro mirror array 112. Alternatively, the angles of the micro mirror array 112 may be adjusted in irradiating the second light passing through the fly's eye lens array 230 to the micro lens array 112.

According to embodiments of the present invention, when the actual pattern has relatively non-uniform critical dimensions, the light intensity distribution of the light may be adjusted by separately changing angles of mirrors of the micro mirror array. Thus, the mask pattern of the photo mask may be accurately transcribed into the wafer so that the pattern on the wafer may have the uniform critical dimensions. More particularly, the exposing process may be readily controlled in accordance with changes of the critical dimensions of the photo mask so that a feedback of the exposing process is carried out relatively easily.

While the present invention has been particularly shown and described with reference to embodiments thereof, it will be understood by those skilled in the art that various changes in form and details may be made therein without departing from the spirit and scope of the invention as defined by the appended claims and their equivalents.

What is claimed is:

1. A method of correcting light intensity for photolithography, the method comprising:
irradiating light having a first light intensity distribution through a photo mask having a mask pattern to a photosensitive layer on a wafer to form a first pattern corresponding to the mask pattern;
determining a distribution of critical dimensions of the first pattern corresponding to the mask pattern;
determining a second light intensity distribution based on a relation between the first light intensity distribution and the distribution of critical dimensions of the first pattern; and
irradiating light having the second light intensity distribution.

2. The method of claim 1, wherein irradiating light having the second light intensity distribution includes irradiating light having the second light intensity distribution through the photo mask having the mask pattern to a photosensitive layer on a wafer to form a second pattern corresponding to the mask pattern.

3. The method of claim 2, wherein the second light intensity distribution is determined so that a uniformity of critical dimensions of the second pattern is greater than a uniformity of critical dimensions of the first pattern.

4. The method of claim 1, further comprising:
storing data representing the second light intensity distribution.

5. The method of claim 1, wherein determining the second light intensity distribution includes:
setting a reference critical dimension;
comparing the reference critical dimension with critical dimensions of the first pattern;
determining a deviation of the distribution of critical dimensions of the first pattern based on comparing the reference critical dimension with critical dimensions of the first pattern; and
obtaining the second light intensity distribution based on the deviation of the distribution of critical dimensions.

6. The method of claim 1, wherein determining the distribution of critical dimensions includes mapping the distribution of critical dimensions of the first pattern and displaying a map of the distribution.

7. The method of claim 1, wherein determining the distribution of critical dimensions includes measuring intensities of the light having the first light intensity distribution irradiated on the photosensitive layer.

8. The method of claim 7, wherein measuring intensities of the light includes measuring the intensities of the light using an optical sensor.

9. The method of claim 1, wherein irradiating light having the second light intensity distribution includes changing paths of portions of the light having the second light intensity distribution relative to paths of corresponding portions of the light having the first light intensity distribution.

10. The method of claim 9, wherein irradiating light having the first light intensity distribution includes reflecting the light off an array of movable micro-mirrors with the movable micro-mirrors being provided in a first orientation, wherein irradiating light having the second light intensity distribution includes reflecting the light off the array of movable micro-mirrors with the movable micro-mirrors being provided in a second orientation, and wherein at least one of the movable micro-mirrors reflects light in different directions in the first and second orientations.

11. A system for correcting light intensity for photolighography, the system comprising:
a light source configured to generate light;
an optical unit configured to selectively change paths of different portions of the light from the light source incident thereon to provide different light intensity distributions for light irradiated through a photo mask having a mask pattern thereon;
a detecting unit configured to detect a distribution of critical dimensions of a first pattern formed in a photosensitive layer on a wafer using a first light intensity distribution provided by the optical unit;
a calculating unit coupled to the detecting unit, wherein the calculating unit is configured to determine a second light intensity distribution different than the first light intensity distribution based on a relation between the first light intensity distribution and the distribution of critical dimensions; and
a control unit coupled to the optical unit and the calculating unit, wherein the control is configured to direct the optical unit to provide the second light intensity distribution for light from the light source incident thereon wherein the first and second light intensity distributions are different.

12. The system of claim 11, further comprising:
a wafer stage configured to receive a wafer having a photosensitive layer thereon and to orient the second photosensitive layer in a path of the light having the second light intensity distribution to provide a second pattern.

13. The system of claim 12, wherein the second light intensity distribution is determined so that a uniformity of critical dimensions of the second pattern is greater that a uniformity of critical dimensions of the first pattern.

14. The system of claim 11, further comprising:
a memory unit configured to store data representing the second light intensity distribution.

15. The system of claim 11, wherein the calculating unit is further configured to set a reference critical dimension, to compare the reference critical dimension with critical dimensions of the first pattern, to determine a deviation of the distribution of critical dimensions of the first pattern based on comparing the reference critical dimension with critical dimensions of the first pattern, and to determine the second light intensity distribution based on the deviation of the distribution of critical dimensions.

16. The system of claim 11, wherein the detecting unit is configured to map the distribution of critical dimensions of the first pattern and to display a map of the distribution.

17. The system of claim 11, wherein the detecting unit includes a sensor configured to measure intensities of the light having the first light intensity distribution irradiated on the photosensitive layer.

18. The system of claim 17, wherein the sensor comprises an optical sensor.

19. The system of claim 11, wherein the optical unit includes an array of movable micro-mirrors and a driver configured to separately adjust orientations of individual ones of the movable micro-mirrors.

20. The system of claim 19, wherein the optical unit is further configured to irradiate light having the first light intensity distribution by reflecting the light off the array of movable micro-mirrors with the movable micro-mirrors being provided in a first orientation, and to irradiate light having the second light intensity distribution by reflecting the light off the array of movable micro-mirrors with the movable micro-mirrors being provided in a second orientation, wherein at least one of the movable micro-mirrors reflects light in different directions in the first and second orientations.
